(19) United States
(12) Patent Application Publication
(10) Pub. No.: US 2008/0054497 A1
(43) Pub. Date: Mar. 6, 2008

(54) VENTED CAP HUMIDIFICATION SYSTEM

(75) Inventors: Keith J. Bradley, Atlanta, GA (US); John Jackson, Buford, GA (US); Juan D. Salleras, Alpharetta, GA (US); Walter R. Sanders, Duluth, GA (US)

Correspondence Address: WOOD, HERRON & EVANS, LLP, 2700 CAREW TOWER, 441 VINE STREET, CINCINNATI, OH, 45202, US

(73) Assignee: MEDEX CARDIO-PULMONARY, INC.., Carlsbad, CA (US)

(21) Appl. No.: 11/469,086

(22) Filed: Aug. 31, 2006

(51) Int. Cl. B01D 47/00

(52) U.S. Cl. 261/19

(57) ABSTRACT

A chamber-to-reservoir vented humidification system in which the reservoir is an inverted water bottle elevated above the humidification chamber. A vented cap is provided to couple water from the bottle to the chamber via a supply line coupled between a water port of the cap and a water inlet of the chamber, and to provide a vent between the chamber and the bottle via a vent line coupled between a vent port of the cap and a vent of the chamber. A straw couples the vent port to a space within the inverted bottle spaced from the cap, such as above the water line. The vented cap includes a duckbill valve in the vent port.

### FIELD OF THE INVENTION

The present invention relates to humidification systems, and more particularly, to humidification systems with a chamber-to-reservoir venting system.

### DESCRIPTION OF PRIOR ART

Humidification chambers provide a vehicle for imparting moisture and possibly heat to an air stream to assist with patient breathing. The chamber is adapted to hold water in its interior, such that a breathable gas passed over, or through, the water will pick up moisture as it passes through the chamber. Many such chambers are further adapted to be heated, such that the breathable gas is also warmed as may be desired for many situations. The breathable gas may be coupled into the chamber interior via a gas inlet communicating through a wall of the chamber. The breathable gas passes over and/or through the water in the chamber, and back out to a patient via a gas outlet communicating through a wall of the chamber.

The chamber may be kept filled with water from a reservoir, such as a bag or bottle of water, coupled to a water inlet of the chamber via a supply line. In many cases, the water inlet is coupled through a top wall of the chamber and the water is fed into the chamber via a gravity feed through the water inlet. In order to prevent the chamber from flooding, and to otherwise regulate the water level in the chamber, a float valve may be provided within the chamber and through which water passes from the water inlet of the chamber, as shown, for example, in Levine U.S. Pat. No. 5,943,473, owned by the assignee hereof and the disclosure of which is incorporated herein by reference in its entirety. An improved float is shown in the concurrently filed U.S. patent application entitled Float for Humidification Chamber, Attorney Docket No. MDXCP-30US, also owned by the assignee hereof and the disclosure of which is also incorporated herein by reference in its entirety.

In some situations, it is desired to vent the chamber interior into the reservoir. Various chamber-to-reservoir vented humidification systems are known in the art, and typically involve either a bottle astride the chamber, such as shown in U.S. Pat. Nos. 4,110,419 and 4,195,044 or Great Britain Patent Publication No. GB 2126102, or a bag elevated above the chamber as shown in Levine U.S. Pat. No. 6,988,497, the latter of which is also owned by the assignee hereof, and the disclosure of which is also incorporated herein by reference in its entirety. The venting is accomplished by coupling a vent line into the chamber at the top thereof, such as into a space of the reservoir above the water level therein.

### SUMMARY OF THE INVENTION

It has been found desirable to utilize a bottle as the reservoir, but elevated above the chamber. Current approaches for chamber-to-reservoir vented humidification systems are believed to present limitations and obstacles to simply elevating the bottle of existing bottle-based systems or to simply replacing the flexible bag of existing elevated bag-based systems with the more rigid bottle. To that end, and in accordance with the principles of the present invention, a venting system is provided by which to utilize an elevated bottle as the water reservoir in a chamber-to-reservoir vented humidification system.

A typical water bottle is a container with a threaded neck defining the opening into the container. A cap, which normally has a top wall and an internally threaded depending skirt, may be threaded onto the neck to close the bottle opening. To facilitate use of the water bottle in a chamber-to-reservoir vented humidification system, the cap has a first or water port opening through the cap top wall and a second or vent port adapted to be coupled to a straw that extends into the bottle.

The vent port is defined by a valve housing molded as part of the cap and a separate valve retainer attached to the cap. The valve housing has an outlet orifice at one end aimed into the bottle and to which the straw is coupled. The other end of the valve housing defines an opening through which to receive a check valve, such as a duckbill valve. The valve retainer is attached to the cap at the opening of the valve housing to hold the valve therein. The valve retainer has an inlet orifice at one end spaced from the valve housing opening and to which the vent line is coupled. When the bottle is inverted, the water port confronts the water to couple water therethrough and into a humidification chamber via a supply line attached between the chamber and the water port of the bottle. The straw extends into the bottle and opens spaced from the cap so as to reduce the head of water on the valve and assist in venting the bottle to the chamber via a vent line attached between the chamber and the vent port. The check valve is oriented so as to open in response to a greater pressure at the inlet orifice relative to the outlet orifice (which could be due to water evacuating the bottle through the water port and/or a positive pressure pulse from within the chamber), but not in response to either no pressure differential or a greater pressure at the outlet orifice relative to the inlet orifice (such as might occur during a negative pressure pulse within the chamber). The check valve can also serve to prevent accidental evacuation of water through the vent port. The valve housing advantageously depends from the top wall within the skirt, such that the valve housing and outlet orifice do not extend beyond the plane of the cap opening. The straw may extend into the bottle sufficiently to open above the surface of the water in the inverted bottle. Alternatively, or additionally, the straw may extend into the bottle sufficiently to open at or near the water surface, but not necessarily thereabove, such as where the straw is flexible or before water begins to empty out of the bottle.

A gasket may be provided within the skirt on the underside of the cap top wall to form a seal with the upper end of the neck of the bottle. Advantageously, the skirt ends in a planar, annular surface. The bottle may also be provided with a planar annular surface along the bottle top wall and encircling the neck. The two planar surfaces cooperate to provide a further seal with the cap screwed onto the bottle neck.

A chamber-to-reservoir vented humidification system includes a humidification chamber and an inverted water bottle. The water bottle has a vented cap, with a water port coupled via a supply line to a water inlet of the chamber, which advantageously includes a float valve to regulate flow of water into the chamber from the water bottle. The water bottle has a vent port including a check valve therein, and a straw extending therefrom to open spaced from the cap, such as above the water level in the inverted bottle. The vent port is further coupled via a vent line to a vent inlet of the chamber. The water bottle is held at an elevation above the chamber such that the water level in the bottle is generally higher than the water level in the chamber. The supply and vent lines may be uninterrupted and coupled directly between the chamber and the cap ports.

By virtue of the foregoing, there is thus provided a venting system by which to utilize an elevated bottle as the water reservoir in a chamber-to-reservoir vented humidification system, and which is believed to overcome the limitations and obstacles of existing bottle-based and flexible bag-based chamber-to-reservoir vented humidification systems. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate an embodiment of the invention, and together with the general description of the invention given above, and the detailed description of the embodiments given below, serve to explain the principles of the present invention.

FIG. 1 is a perspective, diagrammatic view of a chamber-to-reservoir vented humidification system constructed in accordance with the principles of the present invention;

FIG. 2 is an exploded, perspective partial view of the bottle, vented cap, supply and vent lines, and straw used in the system of FIG. 1;

FIG. 3 is a cross-sectional view of the vented cap used in the system of FIG. 1;

FIG. 4 is an enlarged view of the area within line 4 of FIG. 3;

FIG. 5 is a view taken along line 5-5 of FIG. 4; and

FIG. 6 is an enlarged view of the area within line 6 of FIG. 3.

### DETAILED DESCRIPTION OF THE DRAWINGS

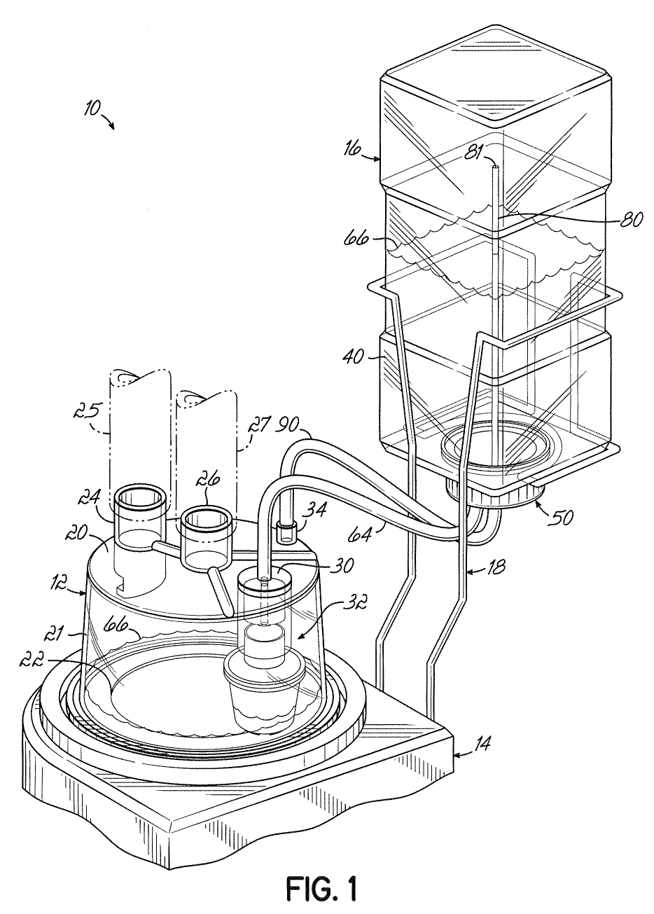

With reference to FIG. 1, there is shown an exemplary chamber-to-reservoir vented humidification system 10 constructed in accordance with the principles of the present invention. To that end, system 10 includes a humidification chamber 12 mounted in heat transfer relationship atop a heater base 14, and a water reservoir bottle 16 held, such as by rack 18, so as to be inverted and generally elevated relative to chamber 12. Chamber 12 has a top wall 20 and a side wall 21, which may be a single plastic housing section, and a bottom wall 22 joined to side wall 21. Communicating through top wall 20 is a gas or air inlet 24, which may be coupled to an air hose 25 (shown in dashed line) to receive breathable gas into chamber 12. Breathable gas passes out of chamber 12 via gas or air outlet 26, also communicating through top wall 20. Gas outlet 26 may be coupled via an air hose 27 (shown in dashed line) to a patient (not shown) to provide breathable gas that has picked up moisture and possibly heat as it traveled through chamber 12 as is conventional. Also communicating through top wall 20 of chamber 12 is a water inlet 30 which couples into chamber 12 via float valve 32. Chamber 12 further includes a vent 34 communicating through top wall 20. The foregoing construction of chamber 12 may be as described in aforementioned U.S. Pat. Nos. 5,943,473 and 6,988,497 or aforementioned concurrently filed U.S. patent application entitled Float for Humidification Chamber, Attorney Docket No. MDXCP-30US.

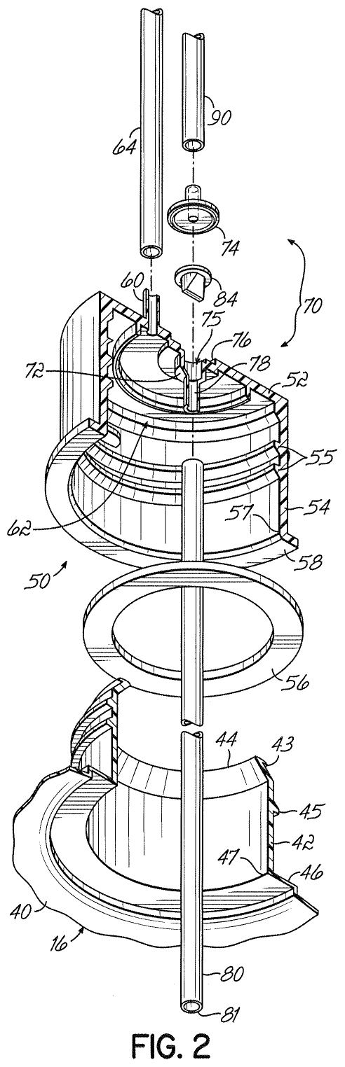

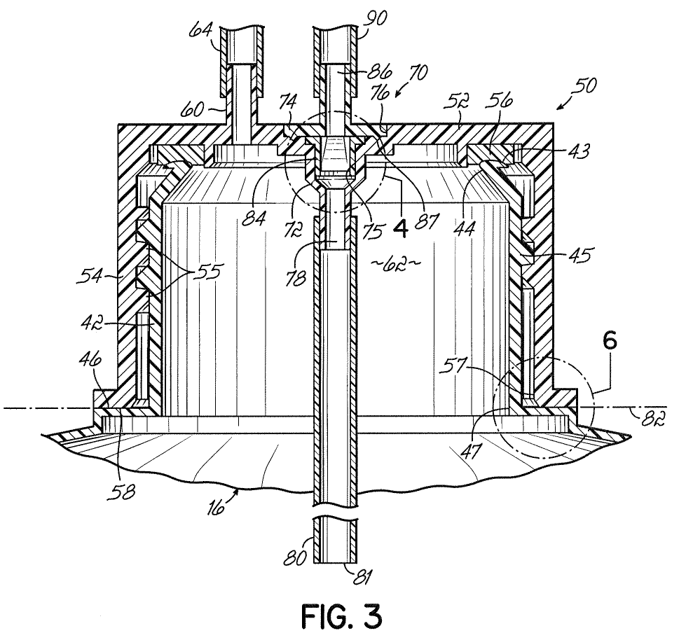

Bottle 16 is defined by a generally rigid or semi-rigid container body 40 (as opposed to the flexible walls of a bag) and may further be rectangular in cross section as seen in FIG. 1. With further reference to FIGS. 2 and 3, extending from body 40 is a tubular neck 42 terminating at peripheral edge 43 to define opening 44 of bottle 16. Neck 42 has external threads 45. Bottle 16 may include a flat or planar annular surface 46 adjacent base 47 of neck 42. Bottle 16 is closed by vented cap 50 which is molded plastic having a top wall 52 and a depending skirt 54. Skirt 54 has internal threads 55 to threadingly engage threads 45 of neck 42 to secure cap 50 to bottle 16. A gasket 56 may be included in cap 50 adjacent the underside of top wall 52 to seal against edge 43 of neck 42 (FIG. 3). Skirt 54 may terminate at its free end 57 in a flat or planar annular surface 58 which mates up against annular surface 46 of bottle 16 to define a further or secondary seal thereat (FIGS. 3 and 6).

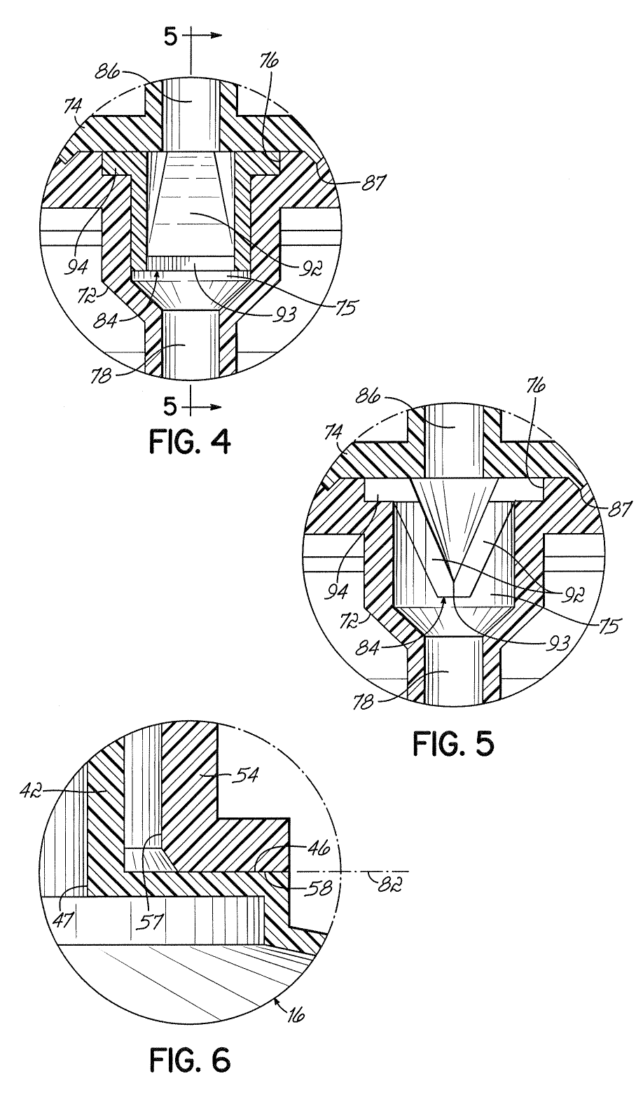

Cap 50 is advantageously a plastic molded component which includes molded into cap top wall 52 a water port 60 opening into area 62 of cap 50 within skirt 54 and below top wall 52. Uninterrupted supply line or tubing 64 is attached at one end to water port 60 (FIG. 3) and at its other end to water inlet 30 of chamber 12 (FIG. 1) so as to couple water 66 from within bottle 16 into chamber 12 via float valve 32. Cap 50 also includes a vent port 70, which in the embodiment shown, is defined by valve housing 72 and valve retainer 74. As seen in greater detail in FIGS. 4 and 5, valve housing 72 is integrally molded in the top wall 52 of cap 50 so as to define (a) valve space 75 opening out of top wall 52 at opening 76 and (b) outlet orifice 78 to which is coupled tubing or straw 80 which extends to an open end 81. Straw 80 may be rigid, semi-rigid or flexible, provided it has enough firmness to extend upwardly when cap 50 is held upside down such as when bottle 16 is inverted as seen in FIG. 1 so as to space open end 81 of straw 80 from cap 50. Housing 72 extends from the underside of cap top wall 52 within area 62 and, advantageously, is completely within area 62 such that outlet orifice 78 does not extend beyond plane 82 defined by annular surface 58 of skirt 54.

A check valve, such as a duckbill valve 84, is fitted into valve space 75 through opening 76. Valve retainer 74 is secured to top wall 52 at opening 76, such as by adhesive or ultrasonic welding, so as to secure valve 84 therein in communication with valve port 70. Valve retainer 74 has an inlet orifice 86 at one end spaced from the cap top wall 52, and may include at the other end an annular edge 87 to form a seal with opening 76 of cap top wall 52. Uninterrupted vent line or tubing 90 is attached at one end to inlet orifice 86 of vent port 70 (FIG. 3) and at its other end to vent 34 of chamber 12 (FIG. 1) so as to vent chamber 12 into reservoir bottle 16. Straw 80 extends into bottle 16 so as to space open end 81 from cap 50 and, in the embodiment shown herein, spaced from valve 84 and beyond plane 82 of cap 50, so as to reduce the head of water imposed on valve 84. Straw 80 may extend into bottle 16 so that its open end 81 is above the level of water 66 therein when bottle 16 is inverted as seen in FIG. 1. It will be appreciated, however, that if bottle 16 is full, open end 81 may be at or near (and possibly slightly below) the level of water 66 until after some of water 66 has emptied out therefrom. Further, straw 80 could be flexible such that open end 81 tends to move with the water level while being just below, at, or just above the water level.

Valve 84 advantageously is a duckbill valve which is characterized by a pair of opposed, canted walls 92 that join at a slit 93, and has a base flange 94 to support it at opening 76 of cap 50 (FIGS. 4 and 5). Valve 84 is advantageously normally closed and oriented so as to open in response to a greater pressure at the inlet orifice 86 relative to the outlet orifice 78 (which could be due to water 66 evacuating the bottle 16 through the water port 60 and/or a positive pressure pulse from within the chamber 12), but not in response to either no pressure differential or a greater pressure at the outlet orifice 78 relative to the inlet orifice 86 (such as might occur during a negative pressure pulse within the chamber 12). The check valve 84 can also serve to prevent accidental evacuation of water 66 through the vent port 70.

In use, vented cap 50 is screwed onto bottle neck 42, with straw 80 extending into bottle 16. Supply line 64 and vent line 90 are coupled at one end to water port 60 and vent port 70 of cap 50 and at the other end to water inlet 30 and vent 34 of chamber 12, respectively. Bottle 16 is inverted and held generally elevated relative to chamber 12 such that the level of water 66 in bottle 16 is above the level of water 66 in chamber 12. The patient (not shown) is ventilated or otherwise assisted in breathing with breathable gas passed through chamber 12 to pick up moisture and heat from water 66 within chamber 12. Bottle 16 empties of water 66 without difficulty via vent line 90 and without adversely affecting operation of system 10 during positive and/or negative pressure pulses incurring during inspiratory and exhalation pulses within chamber 12.

By virtue of the foregoing, there is thus provided a venting system by which to utilize an elevated bottle as the water reservoir in a chamber-to-reservoir vented humidification system, and which is believed to overcome the limitations and obstacles of existing bottle-based and flexible bag-based chamber-to-reservoir vented humidification systems.

While the present invention has been illustrated by the description of an embodiment thereof, and while the embodiment has been described in considerable detail, it is not intended to restrict or in any way limit the scope of the appended claims to such detail. Additional advantages and modifications will readily appear to those skilled in the art. For example, while valve 84 is shown as communicating with vent port 70 by being mounted to cap 50, a check valve could additionally or alternatively be mounted to open end 81 of straw 80 so as to communicate with vent port 70 via straw 80. Further, valve housing 72 could be located so as to position valve 84 above or astride top wall 52 and could further define the inlet orifice, with the valve retainer being positioned within cap 50 and defining the outlet orifice. Also, bottle 16 could be suspended from a pole or the like. Still further, chamber 12 might not be heated or could be of a different construction and mounted within a heater mechanism. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A humidification system comprising:
a humidification chamber having a water inlet and a vent, and adapted to hold water therein whereby to couple moisture to a breathable gas flowing through the chamber;
a vented cap including a water port and a vent port, the cap adapted to be engaged with a water bottle;
a supply line coupling the water port of the cap to the water inlet of the chamber;
a vent line coupling the vent port of the cap to the vent of the chamber;
a straw extending from the vent port and having an open end adapted to be spaced from the cap when cap is engaged to a water bottle; and
a check valve associated with the vent port.

2. The humidification system of claim 1, the vent port including a valve housing, the check valve being within the valve housing.

3. The humidification system of claim 1, the check valve being a duckbill valve.

4. The humidification system of claim 1 further comprising a water bottle, the cap being engaged with the water bottle.

5. The humidification system of claim 4, the straw extending above a water level of water in the water bottle.

6. The humidification system of claim 4, the water bottle being held generally elevated above the chamber.

7. The humidification system of claim 6, the water bottle being inverted.

8. The humidification system of claim 4, the water bottle having a threaded neck and a bottle planar annular surface adjacent a base of the neck, the cap having a threaded skirt terminating in a free edge defining a skirt planar annular surface, the threaded skirt being threadably engaged with the threaded neck such that skirt and bottle annular surfaces are in mating engagement whereby to define a seal thereat.

9. The humidification system of claim 4, the water bottle being inverted.

10. The humidification system of claim 1, the check valve being oriented so as to open in response to a greater pressure at the inlet orifice relative to the outlet orifice.

11. A vented cap for a humidification system comprising:
a top wall, with a skirt depending therefrom;
a water port associated with the top wall;
a vent port associated with the top wall, the vent port having an inlet orifice and an outlet orifice; and
a duckbill valve associated with the vent port between the inlet orifice and the outlet orifice, the duckbill valve being oriented so as to open in response to a greater pressure at the inlet orifice relative to the outlet orifice.

12. The vented cap of claim 11, the vent port including a valve housing associated with the cap top wall and a valve retainer, the duckbill valve being in the valve housing and the valve retainer being attached to the valve housing to contain the duckbill valve in the valve housing.

13. The vented cap of claim 12, the valve housing extending into a space within the cap, but not beyond a plane defined by a free edge of the skirt.

14. The vented cap of claim 11 further comprising a straw coupled to the vent port outlet orifice.

15. The vented cap of claim 11 wherein the skirt terminates in a free edge defining a planar annular surface.

16. A humidification system comprising:
a humidification chamber having a water inlet and a vent, and adapted to hold water therein whereby to couple moisture to a breathable gas flowing through the chamber;
a vented cap including a water port and a vent port, the cap adapted to be engaged with a water bottle;
a supply line coupling the water port of the cap to the water inlet of the chamber;
a vent line coupling the vent port of the cap to the vent of the chamber;
a straw extending from the vent port and having an open end adapted to be spaced from the cap when the cap is engaged with a water bottle; and
a check valve communicating with the vent port.

17. The humidification system of claim 16, the check valve being associated with the cap.

18. The humidification system of claim 16, the check valve being associated with the straw open end.

19. The humidification system of claim 16 further comprising a water bottle, the cap being engaged with the water bottle.

20. The humidification system of claim 19, the straw extending above a water level of water in the water bottle.

21. The humidification system of claim 19, the water bottle being held generally elevated above the chamber.

22. The humidification system of claim 21, the water bottle being inverted.

23. The humidification system of claim 19, the water bottle having a threaded neck and a bottle planar annular surface adjacent a base of the neck, the cap having a threaded skirt terminating in a free edge defining a skirt planar annular surface, the threaded skirt being threadably engaged with the threaded neck such that skirt and bottle annular surfaces are in mating engagement whereby to define a seal thereat.

24. The humidification system of claim 19, the water bottle being inverted.

25. A vented cap for a humidification system comprising:
a top wall, with a skirt depending therefrom;
a water port associated with the top wall;
a vent port associated with the top wall, the vent port having an inlet orifice and an outlet orifice;
a straw coupled to the outlet orifice and having an open end; and
a duckbill valve communicating with the vent port.

26. The vented cap of claim 25, the duckbill valve being associated with the cap.

27. The vented cap of claim 25, the duckbill valve being associated with the straw open end.

28. A bottle for a humidification system comprising:
a body;
a neck extending from the body and joined to the body at a base of the neck; and
the body having a planar annular surface extending completely about the neck adjacent the base thereof.
